(19) United States
(12) Patent Application Publication
(10) Pub. No.: US 2017/0298760 A1
(43) Pub. Date: Oct. 19, 2017

(54) Axial Turbine Engine Compressor De-Icing Blade

(71) Applicant: Safran Aero Boosters SA, Herstal (BE)

(72) Inventor: Frédéric Vallino, Seraing (BE)

(21) Appl. No.: 15/482,108

(22) Filed: Apr. 7, 2017

(30) Foreign Application Priority Data
Apr. 8, 2016 (BE) 2016/5241

(51) Int. Cl. F01D 25/02; F01D 9/04; H05B 1/02; F01D 25/10

(52) U.S. Cl. CPC F01D 25/02; F01D 25/10; F01D 9/041; H05B 1/02; F05D 2230/60; F05D 2220/323; F05D 2250/182; F05D 2250/183; F05D 2270/303; F05D 2240/12

(57) ABSTRACT

An aeroplane turbojet low-pressure compressor vane includes a leading edge, a trailing edge, a surface, and an extrados surface which extend from the leading edge to the trailing edge. To combat the presence and the formation of ice, the vane is provided with an electric de-icing device with a thermistor. The thermistor forms a heating electrical track suitable for de-icing the vane. The present application also proposes a method for producing a turbine engine vane.

This application claims priority under 35 U.S.C. §119 to Belgium Patent Application No. 2016/5241, filed Apr. 8, 2016, titled “Axial Turbine Engine Compressor De-Icing Blade,” which is incorporated herein by reference for all purposes.

### BACKGROUND

### 1. Field of the Application

The present application relates to the field of electric de-icing of turbine engine vanes. The present application also relates to a turbine engine compressor, and a turbine engine like an aeroplane turbojet or an aircraft turbo-prop. The present application also proposes a method for producing a turbine engine vane with an electric de-icing device.

### 2. Description of Related Art

A turbojet is subject to the phenomenon of icing during the operation thereof. Low temperatures combined with the presence of humidity in the air promote the formation of ice on the internal operational surfaces. Of course, this ice adds weight to the turbojet, but above all it affects the proper operation thereof since it changes the profiles of the surfaces guiding the core flow. The overall performance is affected thereby.

Moreover, the thickness of the ice can increase by gradually accumulating on the surface supporting it. This development can result in real blocks of ice which represent potential risks. Indeed, in the case where they detach, the compressor that sucks them in deteriorates. In particular, the rotor blades thereof which hit against them are damaged; and possibly break.

In order to counter both the presence and the appearance of ice, the vanes of the compressor are provided with heating electrical devices. By electrically powering these devices, they heat the vanes by Joule effect. The powering is sufficient to melt the ice that may be present, or to counter the appearance thereof.

Thus, the document GB672658 A discloses a vane for a turbine engine compressor comprising a heating electric element. The vane particularly includes an insulating electric material sheet on which a resistive wire is wound at the surface. The heating element is connected to a power supply. Under icing conditions, an electric current passes through the resistive wire of the heating element and generates heat inside the vane. This allows the ice formed at the surface to be melted and removed. This de-icing system, although effective, remains complex. The cost thereof remains high in addition to it being bulky. Moreover, the precision thereof remains approximate.

Although great strides have been made in the area of axial turbine engine compressors, many shortcomings remain.

DESCRIPTION OF THE DRAWINGS

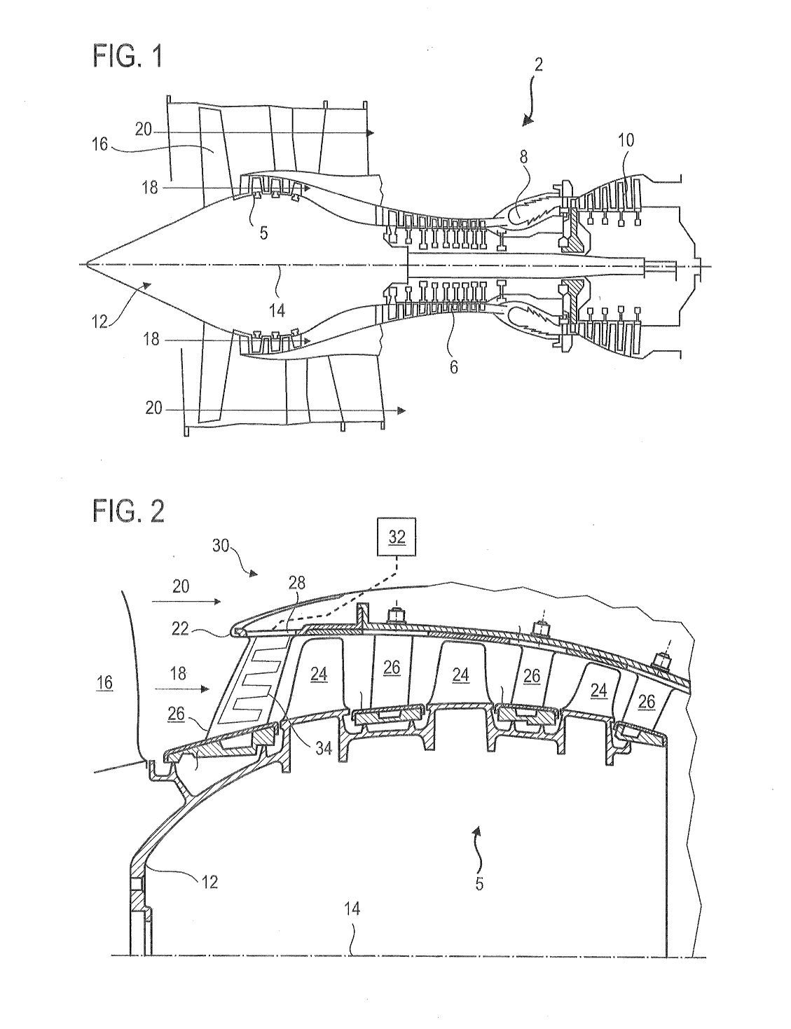

FIG. 1 shows shows an axial turbine engine according to the present application.

FIG. 2 is a diagram of a turbine engine compressor according to the present application.

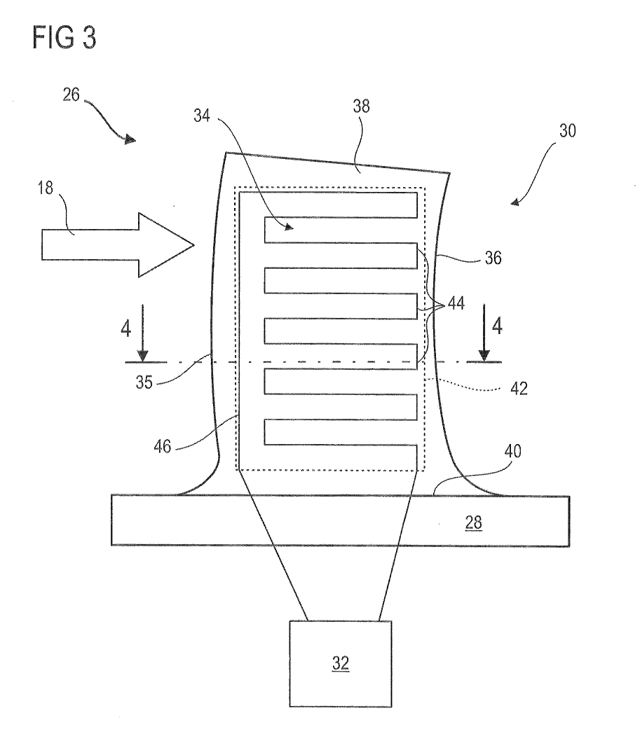

FIG. 3 illustrates a vane and the de-icing device according to the present application.

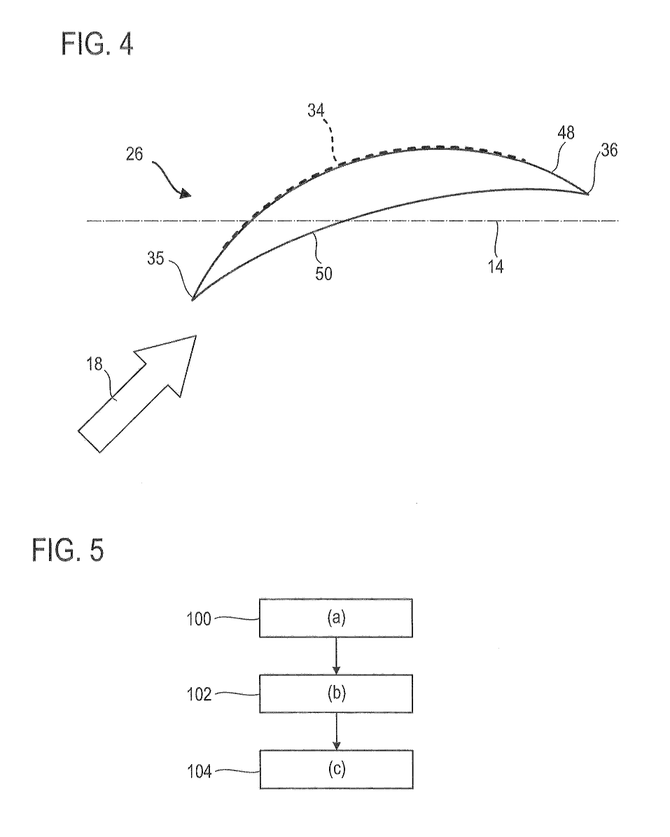

FIG. 4 is a section of the vane along the axis 4-4 plotted in FIG. 3 according to the present application.

FIG. 5 shows a diagram of the method of producing a turbine engine vane with a de-icing device according to the present application.

### DETAILED DESCRIPTION OF THE PREFERRED EMBODIMENT

The present application aims to at least one of the problems presented by the prior art. More precisely, the objective of the present application is to simplify the de-icing of a turbine engine vane. Another objective of the present application is to propose a solution that is compact, economical, robust, and easy to install on an axial turbine engine vane.

The subject matter of the present application is a turbine engine vane, particularly an axial turbine engine stator vane, the vane comprising: a leading edge; a trailing edge; a intrados surface and an extrados surface which extend from the leading edge to the trailing edge; and an electric de-icing device; characterized in that the de-icing device includes a thermistor forming a heating electrical track suitable for de-icing the vane.

According to an advantageous embodiment of the present application, the thermistor is arranged on the extrados surface and/or on the intrados surface of the vane.

According to an advantageous embodiment of the present application, the thermistor is housed in the thickness of the vane between the extrados surface and/or on the intrados surface.

According to an advantageous embodiment of the present application, the thermistor has a positive temperature coefficient or a negative temperature coefficient.

According to an advantageous embodiment of the present application, the thermistor runs along the leading edge and/or the trailing edge of the vane.

According to an advantageous embodiment of the present application, the thermistor is at a distance from the leading edge and/or from the trailing edge of the vane.

According to an advantageous embodiment of the present application, the thermistor extends over the majority of the height of the vane and/or over the majority of the chord of the vane.

According to an advantageous embodiment of the present application, the thermistor forms a conductive ribbon or a cable closely following the extrados surface and/or the intrados surface of the vane.

According to an advantageous embodiment of the present application, the thermistor forms a coil that is put down in a zone occupying the majority of the intrados surface or/and of the extrados surface of the vane.

According to an advantageous embodiment of the present application, the vane comprises a fixing platform, the de-icing device passing through said fixing platform, possibly the thermistor passes through or remains at a distance from said fixing platform.

According to an advantageous embodiment of the present application, the electrical resistance of the thermistor varies from at least 1%, at least 3% or 3%, at least 5% or 5%, at least 10% or 10%, at least 30% or 30%, at least 80% or 80%, when the temperature thereof progresses from 0° C. to −50° C.

According to an advantageous embodiment of the present application, along the height of the vane, the thermistor is arranged at the edges.

According to an advantageous embodiment of the present application, the thermistor joins the root and the tip of the vane, and/or starts from the fixing platform.

According to an advantageous embodiment of the present application, the thermistor comprises a section generally parallel to the leading edge and/or to the trailing edge of the vane.

According to an advantageous embodiment of the present application, the coil forms slots extending from the leading edge to the trailing edge, or from the root to the tip of the vane.

According to an advantageous embodiment of the present application, the thermistor forms a conductive electrical track.

According to an advantageous embodiment of the present application, at 25° C. the thermistor has an electrical resistance greater than or equal to 1 Ω/m, or 10 Ω/m, or 100 Ω/m.

According to an advantageous embodiment of the present application, the thermistor forms the external surface of the vane.

According to an advantageous embodiment of the present application, the vane is intended to be arranged in a flow of the turbine engine, the thermistor being configured such as to be in contact with said flow.

According to an advantageous embodiment of the present application, the length of the press of the thermistor is greater than the height of the vane, and/or the length of the vane. The height of the vane can be equal to the height of the leading edge.

According to an advantageous embodiment of the present application, the track includes a width which is less than: 50% or 30%, or 10%, or 5% or 2% of the length of the chord of the vane.

According to an advantageous embodiment of the present application, the thickness of the vane is less than: 10 mm, or 5 mm, or 2 mm. Said thickness may be an average thickness. It may be measured against and/or along the track.

Another subject matter of the present application is a turbine engine compressor, particularly an axial turbine engine low-pressure compressor, the compressor comprising a vane characterized in that the vane is in accordance with the present application, possibly said vane is arranged in an annular row of vanes at the inlet of the compressor.

Another subject matter of the present application is a turbine engine, particularly an aeroplane turbojet, the turbine engine comprising a vane and/or a compressor, characterized in that the vane is in accordance with the present application, and/or the compressor is in accordance with the present application.

According to an advantageous embodiment of the present application, the de-icing device is configured to measure the temperature of the vane by means of the thermistor.

According to an advantageous embodiment of the present application, the de-icing device is suitable for measuring the temperature of the thermistor by powering it with a first current, and for de-icing the vane by powering the thermistor with a second current greater than the first current.

According to an advantageous embodiment of the present application, the de-icing device comprises a power supply for powering the thermistor such that it heats up by Joule effect.

According to an advantageous embodiment of the present application, the de-icing device is configured to estimate the temperature of the vane by measuring the electrical resistance of the thermistor.

According to an advantageous embodiment of the present application, the second current is at least 50% greater than the first current; or the second current is at least twice, or at least five times, or at least ten times or at least thirty times greater than the first current.

Generally, the advantageous embodiments of each subject matter of the present application can also be applied to the other subject matters of the present application. As far as possible, each subject matter of the present application can be combined with the other subject matters.

Another subject matter of the present application is a method of producing a turbine engine vane with an electric de-icing device, the method comprising the following steps: (a) providing or producing a vane; (b) producing the de-icing device; (c) fixing the de-icing device on the vane; characterized in that the de-icing device comprises a thermistor suitable for de-icing the vane, and in that, during the production step (b), the thermistor is produced by printing; possibly at the end of the fixing step (c), the vane is in accordance with the present application.

According to an advantageous embodiment of the present application, during the step (a) for providing or producing a vane, the vane is produced by powder-based additive manufacturing.

According to an advantageous embodiment of the present application, during the fixing step (c), the thermistor is stuck on the vane.

The present application is advantageous since the use of a thermistor allows both for a heating electrical conductor and a temperature sensor. As a result, a single fixing operation allows two functions to be added to the vane. The production cost and the production time are reduced.

The present application is accurate and effective. It measures as closely as possible the temperature of the vane and provides thereto, still as closely as possible, the necessary calories. The thermistor is therefore suitable for providing a double function on a face directly affected by the ice.

The present application makes it possible to aim for automation of the de-icing device. Using a negative coefficient (NTC) thermistor, it is possible to increase the resistance thereof when the temperature decreases, such that the calories obtained by Joule effect increase for the same powering. The control means can then be simplified and possibly removed.

According to another approach, it can be considered that the layer of ice provides a thermal insulation. As a result, when the temperature should fall due to the altitude but the temperature measured by the thermistor does not consequently fall, more calories must be provided. In this context, a positive coefficient (PTC) thermistor can be used with the aim of self-control.

In the following description, the terms internal and external refer to a positioning with respect to the axis of rotation of an axial turbine engine. The axial direction corresponds to the direction along the axis of rotation of the turbine engine. The radial direction is perpendicular to the axis of rotation. Upstream and downstream refer to the main streaming direction of the flow in the turbine engine.

FIG. 1 shows, in a simplified manner, an axial turbine engine. In this specific case, it is a turbofan engine. The turbojet 2 comprises a first level of compression, called a low-pressure compressor 5, a second level of compression, called a high-pressure compressor 6, a combustion chamber 8 and one or more levels of turbines 10. During operation, the mechanical power of the turbine 10 transmitted via the central shaft up to the rotor 12 moves the two compressors 5 and 6. The latter include several rows of rotor vanes associated with rows of stator vanes. The rotation of the rotor about the axis of rotation 14 thereof thus allows an air flow to be generated and the latter to be gradually compressed up to the inlet of the combustion chamber 8.

An intake ventilator commonly referred to as a fan or blower 16 is coupled to the rotor 12 and generates a flow of air which is divided into a core flow 18 passing through the various aforementioned levels of the turbine engine, and a secondary flow 20 passing through an annular duct (partially shown) along the engine to then re-join the core flow at the turbine outlet. The secondary flow 20 can be accelerated such as to generate a thrust reaction allowing a plane to fly.

FIG. 2 is a sectional view of a compressor 5 of an axial turbine engine such as that of FIG. 1. The compressor can be a low-pressure compressor 5. It is possible to see therein a part of the fan 16 and the splitter 22 for the core flow 18 and the secondary flow 20. The rotor 12 comprises several rows of rotor blades 24, in this case three rows.

The low-pressure compressor 5 comprises several stators, in this case four, which each contain a row of stator vanes 26. The stators are associated with the fan 16 or with a row of rotor blades for correcting the air flow 18, such as to convert the speed of the flow into static pressure.

Advantageously, the blades or vanes (24; 26) of a same row are identical. Optionally, the spacing between the blades or vanes can vary locally just like the angular orientation thereof. Some blades or vanes can differ from the rest of the blades or the rest of the vanes of the row thereof.

The stator vanes 26 can comprise fixing platforms 28 allowing them to be mounted on a support casing, or to the splitter 22, or to an external shroud engaged in the splitter 22. The stator vanes 26 extend mainly radially from the outer casing of the compressor, and can be fixed thereto and immobilized using shafts coming from the fixing platforms 28.

At the inlet, the compressor 5 has an annular row of stator vanes 26, namely that of the upstream stator. Since the latter are particularly exposed to the phenomenon of icing, a de-icing device 30 is provided. The de-icing device 30 groups together a control unit 32 which electrically powers one or more thermistors 34 associated with at least one, or more, or with each vane of the row of stator vanes 26 at the inlet of the compressor. The inlet row is the first row upstream of the compressor.

FIG. 3 outlines a stator vane 26 and the de-icing device 30. The stator vane 26 can correspond to one of the stator vanes described with respect to FIGS. 1 and 2. The fixing platform 28 is visible. Although the present teaching is developed with respect to a stator vane, it can also be suitable for a rotor vane.

The stator vane 26 comprises a leading edge 35 and a trailing edge 36 which extend along the height of the vane 26. The intrados surface and the extrados surface extend from the leading edge 35 to the trailing edge 36 of the vane 26. They join the tip 38 and the root 40 of the vane 26. These surfaces are intended to pass through the core flow 18 and to deflect it in order to make it axial. One of the surfaces, lower or upper, receives the thermistor 34. The latter forms a heating electrical track when it is powered with current. The powering, and the electrical resistance of the thermistor 34 are configured to allow the vane 26 to be de-iced, particularly for the operating temperatures of a turbojet, whether on the ground or at altitude.

The thermistor 34 can form a coil. The coil is housed in a zone 42 which occupies the majority of the intrados surface or of the extrados surface of the vane 26. The coil forms slots 44 occupying the majority of the face receiving the thermistor 34. The slots 44 can display a main elongation arranged along the chord of the vane 26 or along the height thereof.

The thermistor 34 is an electric conductor or can be a semiconductor. It forms a ribbon or a cable. The thermistor 34 extends over substantially the entire height and/or over substantially the entire chord of the vane 26. It runs along the leading edge and the trailing edge. A section 46, for example a radial section, can run along the leading edge 35 and/or the trailing edge 36 of the vane 26. However, this section 46 remains at a distance from the leading edge in order to remain protected. Strips separate the thermistor 34 from the leading edge 35 and from the trailing edge 36. Being set back, the ingestion and abrasion phenomena pose less risk of damaging the thermistor. The life of the device is prolonged.

The thermistor can have a negative temperature coefficient (NTC). A NTC thermistor can comprise an oxide of a transition metal; for example, a manganese oxide, a cobalt oxide, a copper oxide, or a nickel oxide. The NTC thermistor can also comprise a combination of these oxides of transition metals. Alternatively, the thermistor can have a positive temperature coefficient (PTC). The PTC thermistor can comprise a barium titanate, or a polymer alloy. For example, it can comprise one or more of the materials described in the document FR2921194A1.

Although a single vane 26 is shown, it can be envisaged to connect several vanes in parallel and in series, such that the respective thermistors thereof are in turn connected in parallel and in series. Several thermistor vanes can be linked to the same control unit 32.

FIG. 4 shows a section of the vane 26 illustrated in FIG. 3, the section being produced along the axis 4-4. The axis of rotation 14 is drawn as an orientation marker.

The thermistor 34 appears on the extrados surface 48. This position offers a benefit since it is protected from the erosion brought about by the core flow 18. On the illustrated profile of the vane 26, the thermistor 34 remains at a distance both from the leading edge 35 and from the trailing edge 36, but it could touch one of these edges (35; 36), for example the trailing edge 36.

The thermistor 34 covers the extrados surface of the vane 26. It forms, at least partially, the external surface in contact with the core flow 18. Additionally or alternatively, the thermistor 34 can cover the intrados surface 50, in addition to or instead of, respectively, the extrados surface 48.

According to an alternative of the present application, the thermistor can be at the core of the vane, for example in the middle of the thickness of the vane. It can be embedded in the material of the vane, between the intrados surface and the extrados surface. This alternative can also be combined with the aforementioned solutions.

FIG. 5 is a diagram of the method for producing a vane having a de-icing device according to the present application. The vane can be in accordance with that/those described with respect to FIGS. 1-4.

This method can comprise the following steps, possibly carried out in this order:

(a) providing or producing 100 a vane;

(b) producing 102 the de-icing device;

(c) fixing 104 the de-icing device to the vane.

During the provision or production 100 step (a), the vane is produced by powder-based additive manufacturing. The powder can be a titanium powder. The manufacturing can use an electron beam. According to an alternative, the vane can be produced by casting, or be cut from solid.

During the production 102 step (b), the thermistor is produced by printing. A conductive ink, having thermistor properties, is used. It is used on a substrate which is then applied against the vane. The substrate is optionally removed following application. However, the thermistor can be produced using any other means.

During the fixing 104 step (c), the thermistor is stuck on the vane. However, the thermistor can be linked to the vane by being embedded in the thickness thereof.

I claim:

1. A turbine engine vane, comprising:
a leading edge;
a trailing edge;
an intrados surface and an extrados surface which extend from the leading edge to the trailing edge;
a chord; and
an electric de-icing device;
wherein the de-icing device includes a thermistor forming a heating electrical track suitable for de-icing the vane.

2. The turbine engine vane in accordance with claim 1, wherein the thermistor forms the extrados surface of the vane or forms the intrados surface of the vane.

3. The turbine engine vane in accordance with claim 1, wherein the thermistor is housed in the thickness of the vane between the extrados surface and the intrados surface.

4. The turbine engine vane in accordance with claim 1, wherein the thermistor has a positive temperature coefficient.

5. The turbine engine vane in accordance with claim 1, wherein the thermistor has a negative temperature coefficient.

6. The turbine engine vane in accordance with claim 1, wherein the thermistor is at a distance from the leading edge and at a distance from the trailing edge of the vane.

7. The turbine engine vane in accordance with claim 1, wherein the thermistor extends over the majority of the height of the vane and over the majority of the chord of the vane.

8. The turbine engine vane in accordance with claim 1, wherein the thermistor forms at least one of the group consisting of: an electrically conductive ribbon and an electrically conductive cable; which closely follows the extrados surface and/or the intrados surface of the vane.

9. The turbine engine vane in accordance with claim 1, wherein the heating electrical track forms several lines which are joined to each other.

10. The turbine engine vane in accordance with claim 9, wherein each line is biased with respect to its joined line.

11. The turbine engine vane in accordance with claim 1, wherein the thermistor forms zig-zags that are put down in a zone occupying the majority of the intrados surface or of the extrados surface of the vane.

12. The turbine engine vane in accordance with claim 1, further comprising:
a fixing platform, the thermistor passing through said fixing platform.

13. The turbine engine vane in accordance with claim 1, wherein the thermistor forms at least one crenels which extends over the majority of the height of the vane.

14. The turbine engine vane in accordance with claim 1, wherein the thermistor forms several crenels which define several rectangular surfaces between them, said rectangular surfaces occupying the majority of the extrados surface or of the intrados surface.

15. A turbine engine, comprising:
an annular vein and a vane including:
a leading edge;
a trailing edge;
an intrados surface and an extrados surface which extend from the leading edge to the trailing edge; and
an electric de-icing device;
wherein the de-icing device includes a thermistor material forming a heating electrical track suitable for de-icing said vane, said thermistor material comprising:
a surface delimiting the annular vein of the turbine engine.

16. The turbine engine in accordance with claim 15, wherein the de-icing device is configured for measuring the temperature of the vane by means of the thermistor.

17. The turbine engine in accordance with claim 15, wherein the de-icing device is suitable for measuring the temperature of the thermistor by powering the thermistor with a first current, and for de-icing the vane by powering the thermistor with a second current greater than the first current.

18. A method of producing a turbine engine vane with an electric de-icing device, the method comprising:
(a) providing or producing a vane with a leading edge, a trailing edge, an intrados surface and an extrados surface which extend from the leading edge to the trailing edge, and a chord;
(b) producing the de-icing device by printing; and
(c) fixing the de-icing device on the vane;
wherein at (c), the electric de-icing device includes a thermistor forming a heating electrical track suitable for de-icing the vane.

19. The method in accordance with claim 18, wherein during (a) for providing or producing a vane, the vane is produced by powder-based additive manufacturing.

20. The method in accordance with claim 18, wherein during (c), the thermistor is stuck on the vane.
